(19) United States
(12) Patent Application Publication
(10) Pub. No.: US 2019/0076817 A1
(43) Pub. Date: Mar. 14, 2019

(54) METHOD AND APPARATUS USING FOAMED GLASS FILTERS FOR LIQUID PURIFICATION, FILTRATION, AND FILTRATE REMOVAL AND ELIMINATION

(71) Applicants: Andrew Ungerleider, (US); W. Gene Ramsey, (US)

(72) Inventors: Andrew Ungerleider, Sante Fe, NM (US); W. Gene Ramsey, Las Cruces, NM (US)

(21) Appl. No.: 15/704,141

(22) Filed: Sep. 14, 2017

(51) Int. Cl. B01J 20/20; C02F 3/10; C02F 1/28; G21F 9/16; G21F 9/12; C05C 5/00; B01J 20/10; B01J 20/28

(52) U.S. Cl. CPC B01J 20/20; C02F 3/107; C02F 1/288; G21F 9/162; C02F 2101/16; C05C 5/00; B01J 20/103; B01J 20/28045; G21F 9/12

(57) ABSTRACT

A method of disposing of waste material in a waste stream, including positioning a porous foamed glass member characterized by an open-cell interconnected pore network in contact with a volume of liquid to be purified and removing an amount of an undesired material from the volume of liquid.

### CROSS-REFERENCE TO RELATED APPLICATIONS

This patent application is a continuation-in-part of, and claims priority to, co-pending U.S. patent application Ser. No. 11/872,935, filed on Oct. 16, 2007.

### TECHNICAL FIELD

The novel technology relates generally to the materials science, and, more particularly, to a method for using porous foamed glass bodies for the filtration of fluids.

### BACKGROUND

As more and more land is being used for either residential or agricultural purposes, available water for drinking, washing and irrigation is becoming scarcer. Water reclamation, recycling and purification is, accordingly, of increasing importance. One method of removing unwanted particulate material from water or other liquids is via filtration. Organic filters, such as peat, wood chips and the like, have been around for a very long time. However, organic filter material tends to break down into a viscous (and flammable) goo that must be dealt with.

Currently, the most common type of commercial or large-scale water filter is a rapid sand filter. Water passes vertically through sand, which is often arranged having a layer of activated carbon or anthracite coal thereabove to remove organic compounds. The space between sand particles is typically larger than the smallest suspended particles, so simple filtration is typically insufficient. This is addressed by extending the volume of the filter through which the water must pass, so that particles tend to be trapped in pore spaces or adhere to sand particles. Thus, effective filtration is a function of the depth of the filter, and in fact if the top portions were to block all of the filtrate particles, the filter would quickly clog. Although this issue is commonly addressed by using sand with a graded particle size distribution so as to provide a method for removal of various particulates throughout the body, such graded media filters can become quite dense in use as the smaller grade media fill the space between the larger media, resulting again in clogging.

One drawback of sand filters is their great volume. This is addressed by the use of pressure filters. Pressure filters work on the same principle as gravity filters, but for the enclosure of the filter medium is in a (typically steel) vessel through which water is forced under pressure. Pressure filters may filter out much smaller particles than sand filters can, but require bulky and expensive pressure pumps and containment vessels, and are thus unattractive for smaller scale filtration applications.

Another filtration option is the use of membrane filters. Membrane filters are widely used for filtration of both drinking water and sewage. Membrane filters typically employ thin, porous polymer or ceramic members to filters out virtually all particles larger than their specified pore sizes, typically down to about 0.2 microns. The membranes are quite thin and liquids may thus flow through them fairly rapidly. Membranes may be made strong enough to withstand slightly elevated pressure differentials and may also be back flushed for reuse. However, membrane filters offer a low cross-sectional filtration volume, quickly fill up with filtrate and have to be frequently flushed. Thus, there remains a need for a physical filter and method of filtration that utilizes high pore volume and surface area for reacting and/or collecting relatively high volumes of filtrate. The present novel technology addresses this need.

### SUMMARY

The present novel technology relates generally to the use of porous foamed glass bodies filters to purify fluids. One object of the present novel technology is to provide an improved method and apparatus for fluid filtration. Related objects and advantages of the present novel technology will be apparent from the following description.

### BRIEF DESCRIPTION OF THE DRAWINGS

FIG. 1 is a perspective drawing of a block of open pore foamed glass, a component of one embodiment of the present novel technology.

FIG. 2 is a partial cutaway view of a liquid filtration apparatus with open cell foamed glass media filters positioned in a liquid tank according to the embodiment of FIG. 1.

FIG. 3 is a partial cutaway view of the block of FIG. 1 and having a reactive film coating the interior interconnected pore network.

FIG. 4 is a schematic view of a method of disposing waste material captured in an open cell foamed glass member via fusion.

### DETAILED DESCRIPTION OF THE PREFERRED EMBODIMENT

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

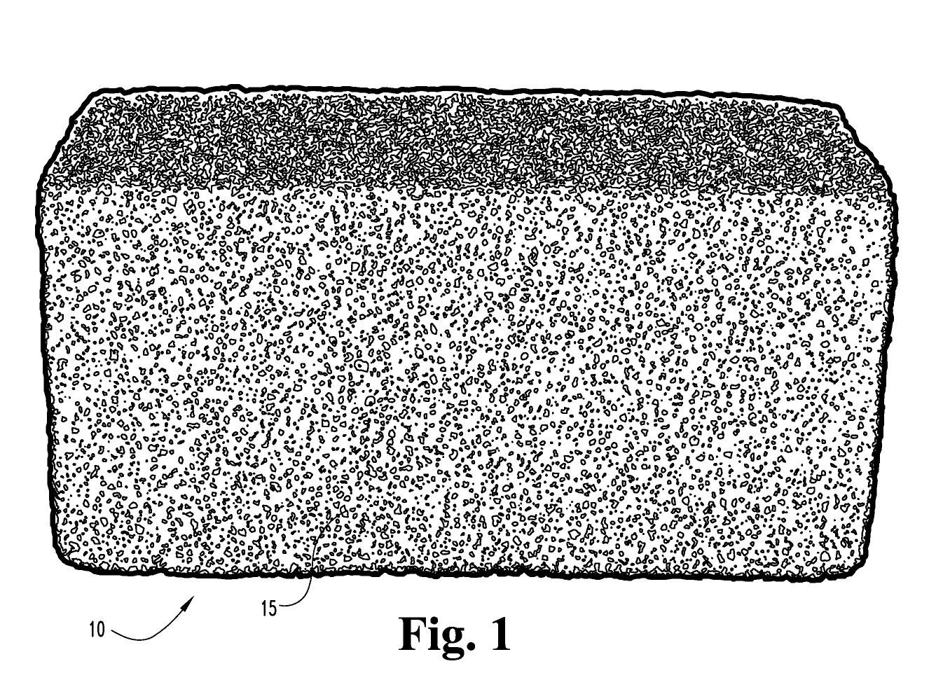

The present novel technology relates to a method of using a porous, open cell foamed glass substrate or filter 10 (see FIG. 1) for filtering impurities from fluids such as water, water vapor, air, and the like, as well as for converting certain impurities into more useful materials. Foamed glass media or members have been adapted for agricultural use—predominately in areas where moisture retention and controlled release, as well as aeration, are important factors in plant growth and health. These foamed glass media are generated with substantial open porosity to enhance water uptake and water availability for root systems, and are likewise applicable for liquid filtration. The filtration applications are for both particulate and monolithic foams 10 and in coated pore wall/non-coated systems.

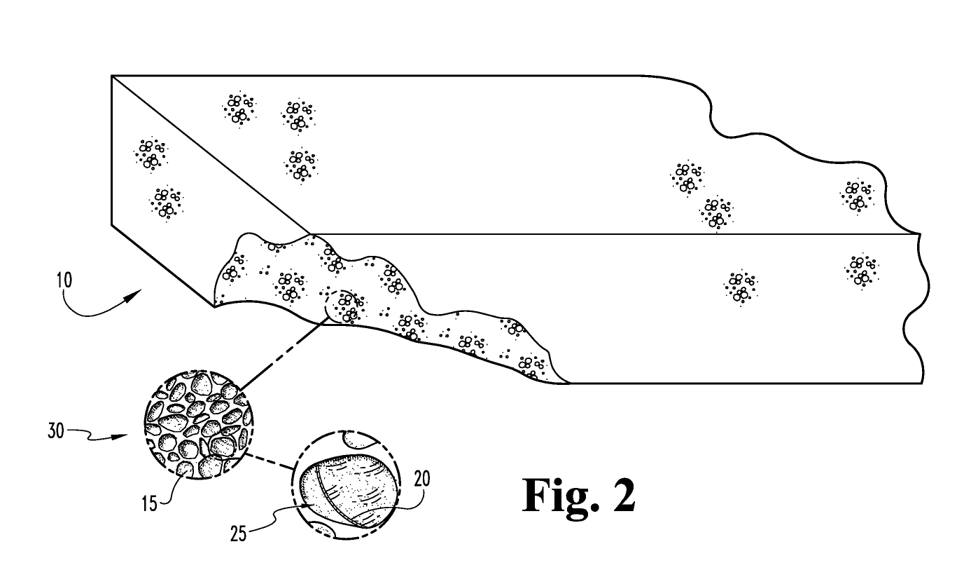

Typically, as illustrated in FIG. 2 in detail, foamed glass filtration media 10 are prepared with networks of interconnected pores 15 ranging from approximately 0.05 to about 0.25 inches diameter. More typically, the pores 15 are highly interconnected to define a pore network 30. The high porosity means that the substrate 10 will have a very high surface area to volume ratio available for filtration and filtrate reaction. These foamed glass media 10 have sufficient porosity to uptake over 150% their own mass in water weight. The water may be retained, be released by gravity or under applied pressure as a function of foam design. The foamed glass filtration media 10 are suitable for use in neutral pH solutions and with most acids, are typically greatly resistant to microbial corrosives, and typically carry a negative surface charge.

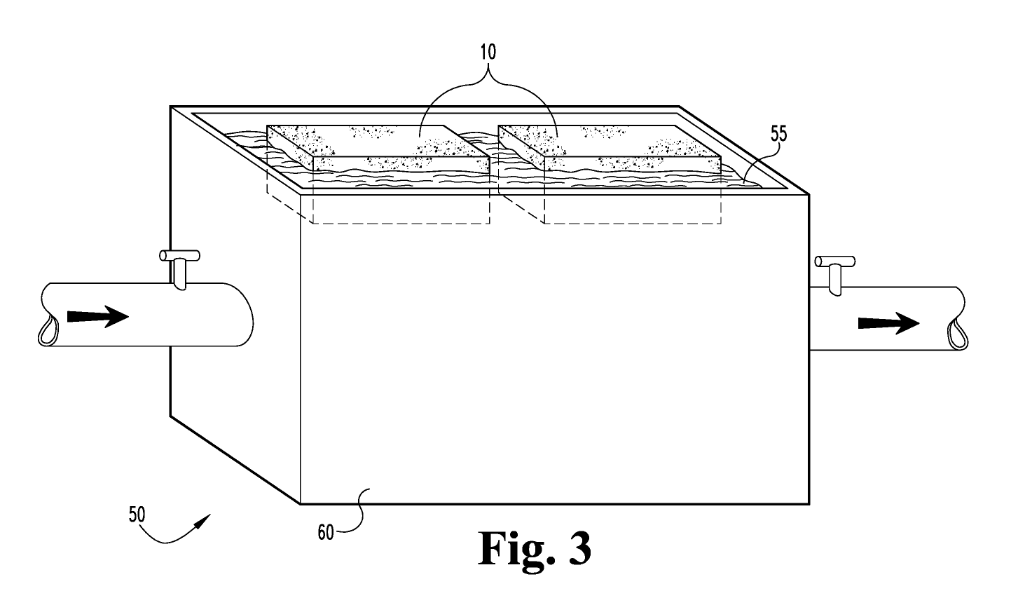

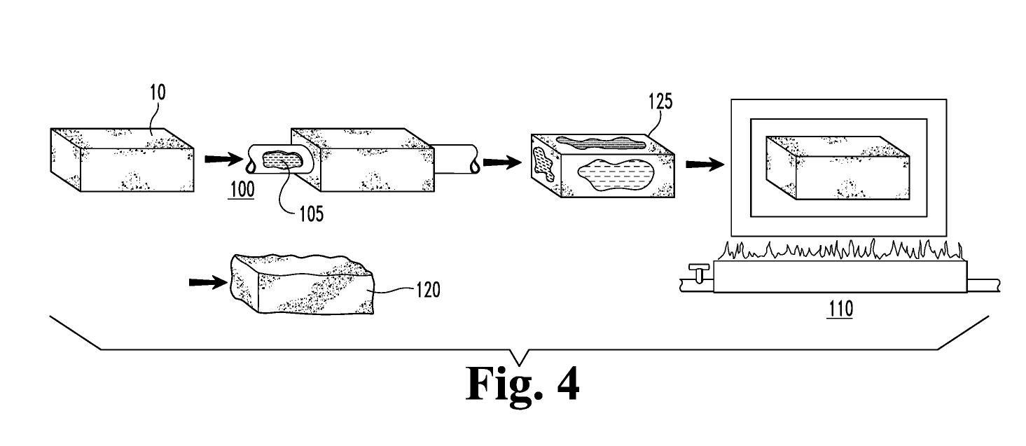

The foamed glass filter media 10 may be monolithic foam systems, where single or multiple foamed glass members 10 are used to filter water or other liquids at up to 80 psi pressure, or the foamed glass filter media 10 may be in the configuration of packed bed filters with pressure tolerance of at least about 160 PSI (see FIG. 3). Such foamed glass filtration media 10 may include a reaction layer 20, such as a surface charge, a biofilm, a carbonaceous layer, or the like formed on the inner pore surfaces 25 for converting filtrate into useful material (such as a biofilm 20 for the conversion of ammonia into nitrates for use as fertilizer). Alternately, the open cell pore network 30 of the foamed glass body 10 may be used for the uptake of nitric acid solutions, such as those comprising common nuclear waste streams, wherein particulate nuclear waste is trapped in the pore network, allowing for the glass and waste component to be vitrified or fused into a single-phase melt, facilitating ultimate disposal (see FIG. 4). Further, the soda lime silica glass system is compatible with ion-exchange resins (both elutable and non-elutable) and can thereby also act as a combination filter/substrate 10 for water purification, in effect simultaneously supplying a composite body consistent with waste vitrification—wherein the glass foam act simultaneously as both a sorbent/transport material and vitrification ready frit. The glass is near intimately mixed with the radionuclide bearing solution by capillary action, acting to limit segregation and improve process mixing prior to and within the melter. Additionally, non-porous, low density glass beads may also be used in conjunction with ion-exchange media, albeit with a significantly lower absorption coefficient.

### Biofilter Operation

FIG. 3 illustrates a filtration system 50 including foamed glass filtration media 10 positioned in liquid communication with a liquid to be purified 55 in a containment vessel 60. In operation, the reaction layer 20 is a biofilm 20 provided on the interior surface 25 of the pore network 30 of blocks or other bodies 10 of the foamed glass material. The biofilm 20 is typically a bacterial colony or the like and is grown to substantially coat at least a portion of the surface area 25 defined by the pore network 30. The biofilm 20 is typically selected for its bioreactive properties, such as the conversion of an undesirable component of the liquid to be filtered into a more desirable material. For instance, some liquid waste streams are high in ammonia. Although ammonia may be desirable in some fertilizer uses, some plants, such as greenhouse tomatoes, prefer nitrates (NO3-) to ammonium (NH4+). Thus, it is desirable to convert ammonium to nitrates and, accordingly, a nitrobacter biofilm 20 is desirable. Such a reaction may be described as follows:

NH₄⁺+O₂→NO₂⁻+H⁺+H₂O (1)

NO₂⁻+O₂→NO₃⁻ (2)

As described above, ammonium is oxidized through the involvement of nitrosomonas (1) and nitrobacters (2) to nitrate filer media 10 with nitrite (NO₂⁻) as an intermediate product. The open cell pore network 30 of the foamed glass is an improvement over polystyrene beads, as the foamed glass provides a stronger, more rigid biofilm support medium, and is less prone to picking up static charges. Further, the foamed glass pore network 30 does not substantially change size or performance in response to temperature or to externally applied compressive forces.

### Nuclear Waste Disposal

Many nuclear wastes are in the form of nitric acid solutions. Most actinide and fission products are stable solutes in the nitric system, and the solutions are not corrosive to stainless steel. Vitrification, a common process for disposition of nuclear wastes, is however, complicated when acids must be converted to silicate (usually borosilcate) glass. Silicates are insoluble in nitric acid, and are thus typically suspended by physical agitation or other means and carefully metered to the furnace to prevent melt inhomogeneity.

Soda-lime glass can be foamed in such a manner to readily sorb nitric acid solutions. The foam glass media 10, in the form of individual particles, can each readily absorb over twice its weight in acid solution and can be directly converted to glass with no physical mixing required. The porous foamed glass media 10 can also act as a carrier of acid solution, as the porous foamed glass media 10 will retain the overwhelming majority of sorbed liquid indefinitely. This allows great range of design for pre-treatment and melter/furnace delivery mechanisms. Further, such a waste disposal system would be attractive in applications where precise knowledge of material accountability is required.

Glasses have been prepared using this novel technology, and are consistent with the requirements for geologic disposal in the U.S. These compositions are borosilicate glasses—part of the highly researched and documented composition range used by the Defense Waste Processing Facility, West Valley Demonstration Project, and the Hanford Waste Treatment Plant. The novel technology is also compatible with specialty waste disposition and also large-scale melter operations.

### Sewerage Treatment

In this example, a filtration system 50 includes foamed glass filtration media 10 positioned in fluidic communication with liquid sewage to be filtered and purified 55, typically in a containment vessel 60. In operation, the reaction layer 20 is a (typically vapor deposited) carbon or charcoal layer 20 provided on the interior surface 25 of the pore network 30 of blocks or other bodies 10 of the foamed glass material. The carbonaceous layer 20 is typically deposited to substantially coat at least a portion of the surface area 25 defined by the pore network 30. The carbonaceous film 20 typically assists both in clearing particulate matter from the sewage stream as well as in neutralizing and eliminating odors. For instance, some liquid waste streams are high in ammonia while others are rich in hydrogen sulfide. The carbonaceous layer helps in the elimination of both odor-causing gasses. Further, the negatively-charged glass surface 25 itself breaks down H₂S upon prolonged contact. This breakdown process is assisted by the reaction layer 20 trapping H₂S and holding it for contact with the glass surface 25, and also by maintaining the pH of the system between 4 and 6 or so; the application of UV light likewise assists in the breakdown of H₂S and like gasses. The glass body 10 and surfaces 25 are also consistent with the application of hydrogen peroxide and like chemicals, as well as combined UV/peroxide treatments.

### Filter Cartridges

In this example, the filtration system 50 includes foamed glass aggregate 10 filling a cartridge 60, which is typically part of a modular system that may be operationally inserted into a waste liquid stream such that the waste liquid is directed to flow therethrough. Alternately, a single larger shaped foamed glass filter bodies, typically formed having large, open porosity, may fill each respective cartridge 60. Once the filtration efficiency of the cartridge 60 declines, it may be removed from service and replaced with a fresh cartridge 60. The used cartridge 60 may have its glass filter material 10 recycled and/or remelted.

All of the above examples exploit the tortuous path provided by the pore network 30 for containment, capture, and/or reaction and conversion of solid, liquid, and/or gaseous contaminants present in the waste stream.

The system 10 is functional to treat waste streams having pH values of between about 10 and about 3, while waste streams having pH values of 5.5-8.0 are typically most efficiently treated. Waste streams having pH values outside the 3-10 range may aggressively degrade the reaction layer 20, the glass itself 10, or both, impairing the synergy enjoyed by the combination of the chemical properties of the reaction layer 20 and the physical and mechanical properties of the glass substrate 10 and pore surfaces 25.

Open cell foamed glass bodies 10 are typically derived from glass precursors that are first pulverized and then softened and foamed to achieve about 90% or greater void space. The pores 15 in the resulting foam are typically on the order of about 0.5 to 2 millimeters in diameter, although the pore size may readily be adjusted. The foamed glass typically each have material density of about 0.2 kg/l prior to crushing and sizing. Crushed foam particles have a typical bulk density between about 0.15 kg/l and about 0.4 kg/l, depending on particle size.

The starting material is typically soda-lime-silica (i.e., window glass); for nuclear processing applications window glass is preferred due to its low concentration of transition metal and sulfur oxides. Foamed glass bodies 10 derived from window glass is pure white (color can be added as required) in color and can be closely sized between ⅛th and 1-inch particles. Monolithic pieces are also readily also be produced.

The porosity of the (>50% open pores) is typically controlled to effectively and rapidly sorb liquids of 10 centipoise or lower viscosity. Typically, a foamed glass body 10 will absorb over 200 percent its weight in water. Further, the foamed glass body typically will retain the liquid indefinitely, with the majority of water loss due strictly to evaporation. Soda-lime glass has excellent chemical stability against nitric acid and is not generally attacked by common acids other than hydrofluoric.

In one embodiment, filter cartridges 60 containing foamed glass aggregate 10 (or, alternately, a single large foamed glass filter body 10) are arranged vertically with the waste stream flowing from bottom to top. This arrangement allows pressure when in use, and also allows for easier cleaning of the filters 60, especially in circumstances when the filtrate particulates are denser than the foamed glass filter medium 10 itself.

### Experimental Data:

Multiple glass products have been generated using the absorptive foam. All glasses were derived from nitric acid solutions roughly similar to PUREX (Plutonium Uranium Redox EXtraction) waste solutions (containing uranium surrogates and other species used to modify the glass processing characteristics) sorbed onto foam glass particles 10. Additionally nitric acid solutions have been prepared with gadolinium and neodymium as a surrogate for uranium. Absorption tests indicate the acid solutions are absorbed in the same manner and to the same degree as water.

In general, the goal was to produce a single phase, homogeneous glass suitable for long-term storage and disposal. As borosilicate glass is the first type of glass accepted for geologic storage in the U.S., the process was tailored to produce a glass of this type, although other glass compositions can likewise be produced. As illustrated schematically in FIG. 4, foamed glass bodies 10 were saturated 100 with an acid solution of nuclear waste material 105 and then fused 110 into generally homogeneous, nonporous vitreous masses 120 for disposal. The nitric acid surrogate waste solutions 115 were doped with boron and lithium (a common glass flux) to generate an end product glass 120 with at least 5 percent by weight boron oxide that would melt at or below 1150° C. (mimicking the process/process region used for U.S. high-level nuclear waste glass). All glasses were prepared in an electric furnace. The materials were added solely in the form of pre-saturated foam 125. No mixing was allowed during the thermal processing. The foam was heated at 5° C. per minute to 800° C. 110 and then additional foam was added as the heated foam re-melted and densified. The final mass was then heated to 1150° C., allowed to soak for 3 hours and then cast onto a cool steel plate to yield a fused, generally nonporous vitreous body 120.

One alternate technique for securing and disposing used filter media 10 infiltrated with low-hazard filtrate is cementation of the foamed glass media 10 to seal the filtrate within the media bodies 10. Application of phosphate or like cement to the exterior of the foamed glass media 10 yields a bonded cementitious outer layer (not shown) over the infiltrated media bodies 10, sealing in the filtrate for disposal and storage.

The preliminary process region appears to be relatively broad, being on the order of:

| | Weight Percent |
|---|---|
| Soda-Lime Glass | 50 to 80 |
| Boron Oxide | 5 to 15 |
| Re₂O₃ | 0 to 10 |
| R₂O | 5 to 15 |

Wherein Re₂O₃ represent rare earth oxides. Actinides are nominally less soluble on a molar basis, but have a greater atomic mass. Uranium, especially, is quite soluble in glass. Additional species can be added to the glass composition region if increased durability or decreased viscosity is desired. This process may likewise be used to dispose of waste streams containing non-radioactive heavy metal cations.

While the novel technology has been illustrated and described in detail in the drawings and foregoing description, the same is to be considered as illustrative and not restrictive in character, it being understood that only the preferred embodiment has been shown and described and that all changes and modifications that come within the spirit of the novel technology are desired to be protected.

We claim:

1. A method of treating fluids, comprising:
a) directing a fluid to be purified into a porous foamed glass member, wherein the foamed glass member is characterized by an open-cell interconnected network of pores, wherein each pore is defined by at least one pore wall and wherein the fluid contains at least one odorant;
b) contacting the at least one odorant with the at least one pore wall; and
c) removing the odorant from the fluid.

2. The method of claim 1 wherein c) further comprises chemically reacting the odorant to yield a non-odorant product.

3. The method of claim 1 wherein c) further comprises capturing the odorant.

4. The method of claim 1 wherein the open-cell interconnected network of pores further defines a reaction surface and further comprising a reactive film substantially disposed on the reaction surface, wherein the reactive film is operable to convert at least some waste material into a predetermined useful material.

5. The method of claim 4 wherein the fluid is an ammonia solution, wherein the reactive film is a biofilm capable of converting ammoniums into nitrates and wherein the predetermined useful material is a nitrate fertilizer.

6. The method of claim 4 wherein the fluid is a hydrogen sulfide solution, wherein the reactive film is a carbonaceous film capable of at least temporarily capturing the hydrogen sulfide for chemical breakdown at the pore walls.

7. The method of claim 1 wherein the liquid is an acid solution containing nuclear waste.

8. A method of disposing of waste material in a waste stream, comprising:
a) positioning a porous foamed glass member characterized by an open-cell interconnected pore network in contact with a volume of fluid to be purified; and
b) removing an amount of an undesired material from the volume of fluid.

9. The method of claim 8 wherein the undesired material is transformed into a different material.

10. The method of claim 9 wherein the undesired material is hydrogen sulfide.

11. The method of claim 8 and further comprising:
c) disposing a reactive material against the foamed glass for capturing the undesired material.

12. The method of claim 11 wherein the reactive material is a charcoal.

13. The method of claim 12 wherein the charcoal is capable of capturing hydrogen sulfide for reaction against negatively charged pore walls.

14. The method of claim 8 and further comprising:
c) heating the porous foamed glass member sufficiently to fuse the porous glass member and any contents into a substantially nonporous glass body.

15. The method of claim 14 wherein the undesired material is an acid solution of nuclear waster products and wherein the substantially nonporous glass body includes nuclear waste products dissolved in a vitreous material.

16. The method of claim 14 wherein the undesired material contains heavy metal cations.

17. A method of filtering a liquid, comprising:
a) positioning an open-cell interconnected glass pore network in fluidic communication with a volume of fluid to be purified;
b) infiltrating an amount of waste material into the pore network; and
c) disposing of the waste material.

18. The method of claim 17 wherein the waste material is disposed of through conversion into a useful material.

19. The method of claim 17 wherein the waste material is disposed of through fusion of the pore network and waste material into a vitreous body.

20. The method of claim 17 wherein the waste material is a particulate filtrate and wherein the waste material is disposed of through physical removal from the fluid.
